(19) United States
(12) Patent Application Publication
(10) Pub. No.: US 2007/0025599 A1
(43) Pub. Date: Feb. 1, 2007

(54) Sensor array spherical member barrier apparatus and method

(76) Inventor: Carl N. Garcia, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/189,473

(22) Filed: Jul. 26, 2005

(51) Int. Cl. G06K 9/00

(52) U.S. Cl. 382/124

(57) ABSTRACT

A sensor array (200) comprises a plurality of electrically conductive sensor element pads (201) that are separated from one another by intervening gaps (202). Barriers (301), comprising raised barriers in one approach and having a cross-sectional shape of choice, serve to urge electrically conductive substantially spherical members (1301) away from positions such as those that would lead to inappropriately electrically coupling two or more adjacent pads.

### CROSS-REFERENCE TO RELATED APPLICATIONS

The present application is related to the following U.S. application commonly owned together with this application by Motorola, Inc.:

Ser. No. 10/006461, filed Dec. 6, 2001, titled “Method and Apparatus for Asperity Sensing and Storage” by Goodman, et al. (attorney docket no. CM014971).

### FIELD OF THE INVENTION

The present invention relates generally to sensor arrays and more particularly to sensor arrays employing electrically conductive substantially spherical members.

### BACKGROUND OF THE INVENTION

Sensor arrays that employ electrically conductive substantially spherical members are known. Asperity detectors making use of such spherical members have been proposed, for example. In such a configuration, the electrically conductive substantially spherical members typically serve as an electrically conductive path between asperities of interest (such as human fingerprint ridges) and asperity detection/storage cells. In such an arrangement, the sensor array may comprise a plurality of small sensor elements that are separated from one another by relatively small distances.

The substantially spherical members, on the other hand, are often provided in a variety of sizes (with such non-uniformity regarding size typifying present commercially viable quality controls and manufacturing tolerance capabilities). In some cases, and particularly when considering a relatively high resolution sensor array (offering, for example, 1000 dpi or higher resolution) having many small sensor elements and relatively small gaps therebetween, at least some of the spherical members may be of suitable size to potentially electrically bridge adjacent sensor elements and thereby render them ineffective for their purpose.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 comprises a flow diagram as configured in accordance with various embodiments of the invention;

FIG. 2 comprises a top plan schematic view as configured in accordance with various embodiments of the invention;

FIG. 3 comprises a top plan schematic view as configured in accordance with various embodiments of the invention;

FIG. 4 comprises a side elevational sectioned schematic detail view as configured in accordance with various embodiments of the invention;

FIG. 5 comprises a side elevational sectioned schematic detail view as configured in accordance with various embodiments of the invention;

FIG. 6 comprises a side elevational sectioned schematic detail view as configured in accordance with various embodiments of the invention;

FIG. 7 comprises a side elevational sectioned schematic detail view as configured in accordance with various embodiments of the invention;

FIG. 8 comprises a side elevational sectioned detail view as configured in accordance with various embodiments of the invention;

FIG. 9 comprises a side elevational sectioned detail view as configured in accordance with various embodiments of the invention;

FIG. 10 comprises a side elevational sectioned detail view as configured in accordance with various embodiments of the invention;

FIG. 11 comprises a side elevational sectioned detail view as configured in accordance with various embodiments of the invention;

FIG. 12 comprises a side elevational sectioned detail view as configured in accordance with various embodiments of the invention;

FIG. 13 comprises a top plan schematic view as configured in accordance with various embodiments of the invention; and

FIG. 14 comprises a top plan schematic detailed view as configured in accordance with various embodiments of the invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for sensor array spherical member barrier. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Generally speaking, pursuant to these various embodiments, provision of a sensor array is facilitated through provision of a plurality of discrete electrically conductive pads and at least one barrier (wherein the barrier may be comprised of insulating material). A plurality of electrically conductive substantially spherical members are then disposed over the plurality of discrete electrically conductive pads such that the one or more barriers serve to urge one or more of the spherical members away from a position towards which the spherical member is otherwise inclined to assume.

Such barriers can be disposed within (or external to) the gaps that separate the conductive pads from one another. In one optional approach, the barrier comprises a raised barrier having an uppermost portion that extends outwardly beyond a proximal portion of an adjacent conductive pad or pads. The barrier can have any of a wide variety of cross-sectional shapes, including but not limited to a rectangular shape, a curved shape, a stepped shape, a tapered shape, and so forth. A particular shape may be selected based, for example, upon specific needs or desires with respect to anticipated interaction with corresponding spherical members.

So configured, the electrically conductive substantially spherical members can be substantially (or even fully) diverted from becoming positioned in a manner that would otherwise likely lead to creation of an undesired electrical pathway between adjacent conductive pads. This, in turn, can greatly aid in assuring the operational integrity of the various conductive pads notwithstanding relatively small gaps between such pads and further notwithstanding a presence of spherical members having considerably differing respective sizes. These teachings are cost effective and are relatively friendly in a manufacturing context as well.

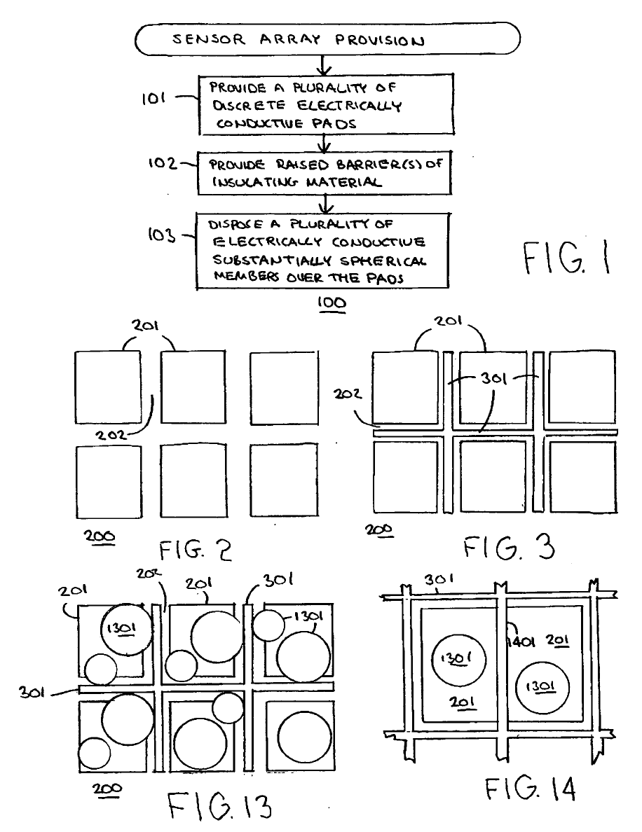

These and other benefits may become clearer upon making a thorough review and study of the following detailed description. Referring now to the drawings, and in particular to FIG. 1, these teachings provide for a process 100 that itself provides for provision 101 of a plurality of discrete electrically conductive pads. These pads serve, in an illustrative embodiment, as an input to corresponding discrete sensor element cells (the interested reader can learn more regarding such cells and the sensor arrays formed thereby by referring to United States Publication US 2003-0108226 A1 as was published on Jun. 12, 2003).

These pads are typically formed on an insulating surface of choice and are themselves sized to accommodate a desired degree of sensor resolution. Such pads can be, for example, about 50 or even 100 microns across, and in one embodiment (suitable to support, for example, 1000 dpi resolution) about 25 microns or less may be desired. Each pad can have a footprint shape as may best suit the needs and/or requirements of a given application though a square-shaped form factor will likely be suitable for many applications. A typical sensor array may comprise many thousands (or at least many hundreds) of such pads.

In one approach, and referring momentarily to FIG. 2, such a sensor array 200 having a plurality of such discrete electrically conductive pads 201 can feature gaps 202 that serve, at least in part, to separate the pads 201 from one another. This separation can aid in facilitating, for example, electrical isolation as between these pads 201. The gap 202 can be sized as may be appropriate to the needs of a given application though 10 microns or less will likely be suitable for higher resolution sensor arrays. Pursuant to one approach, these gaps 202 may be formed by selectively etching away the electrically conductive material that serves to define the pads 201 in accordance with well-understood prior art techniques. Those skilled in the art will understand and appreciate, however, that additive processes may be employed as well if so desired.

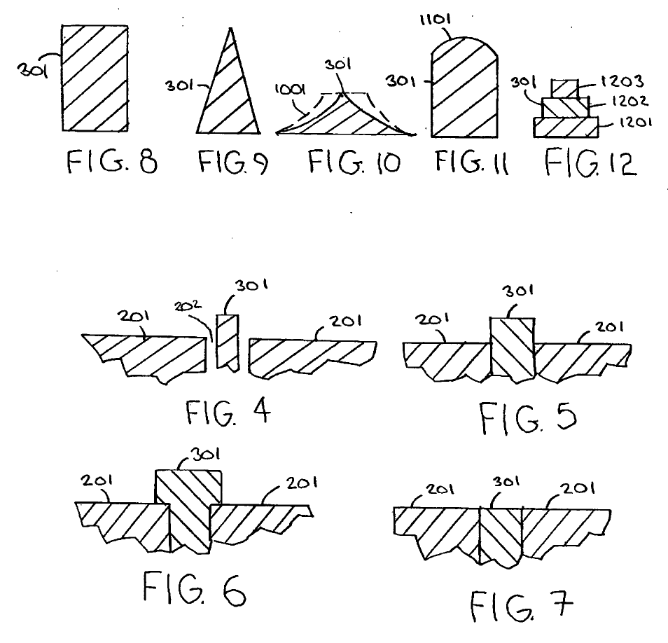

Referring again to FIG. 1, this process 100 my also provide for provision 102 of at least one (and usually many) raised barrier that may be comprised of electrically insulating material. Referring momentarily to FIG. 3, such barriers 301 can be disposed, for example, at least partially within the aforementioned gaps 202. (In one embodiment it may also be desirable to place such barriers around the periphery of the sensor array 200 as well (not shown).) In one optional embodiment, such barriers 301 have an uppermost portion that extends outwardly from the sensor array 200 beyond a proximal portion of at least one of the conductive pads 201 as illustrated, for example, in FIG. 4. With continued momentary reference to FIG. 4, the barrier 301 can be disposed within, but not completely fill, the gap 202 between adjacent pads 201. In such a case, if desired, other material (not shown) can be used to partially or wholly fill the remaining potions of the gap 202.

Pursuant to another approach, and referring now to FIG. 5, if desired the barrier 301 can substantially completely fill the space available between adjacent conductive pads 201. Pursuant to yet another approach, and referring now to FIG. 6, it is also possible to configure the barrier 301 to have an upper portion that extends laterally beyond the dimensions of the gap itself (with this approach possibly being suitable in settings where a relatively wider barrier might offer some relative advantage). As noted above, these barriers 301 are usually higher than the pads 201. If desired, however, and as illustrated in FIG. 7, one or more such barrier 301 can be essentially flush with the plane that contains the pads 201 themselves.

The barriers 301 can be formed to have any of a wide variety of cross-sectional shapes. For example, and referring now to FIG. 8, the barrier 301 can have a substantially rectangular cross-section. Or, if desired, the barrier 301 can have a substantially tapered cross-section (such as a triangularly shaped cross-section as is shown in FIG. 9 or a substantially chevron shaped cross-section as is shown in FIG. 10 (wherein the chevron shaped embodiment may comprise a chevron having a pointed peak as shown or, for example, a truncated peak as illustrated by the phantom lines 1001)). As yet another example, and referring now to FIG. 11, the barrier 301 can have a substantially curved cross-section as where at least an upper portion of the barrier 301 has at least a partially rounded cross-section. Other possibilities exist as well, such as a substantially stepped cross-section as is depicted in FIG. 12 (which illustrates a barrier 301 comprised of three insulating material layers 1201, 1202, and 1203 that are each successively smaller than the adjacent lower layer to yield yet another approach to achieving a substantially tapered cross-section).

The particular shape (or shapes) selected for use in a given instance will of course depend, at least in part, upon the desired purpose and intended performance requirements. In general it may be observed that different cross-sectional shapes will, in turn, tend to interact somewhat differently with spherical-shaped members as are introduced below. In general, the rounded and tapered configurations may tend to assist in urging such sphere-shaped members away from positions at rest atop such barriers.

Referring again to FIG. 1, this process 100 then provides for disposing 103 a plurality of electrically conductive substantially spherical members over the plurality of discrete electrically conductive pads. In one approach, at least one of the aforementioned raised barriers serves to urge at least one of the spherical members away from a position towards which that spherical member might otherwise be inclined. For example, when a given barrier is disposed within a gap between two pads, that barrier will tend to prevent a spherical member from coming to rest in a position that would otherwise physically and electrically bridge that gap. This can comprise, for example, elevating such a spherical member away from the pads as when the barrier has a relatively flat upper surface or urging the spherical member laterally away from the gap as when the barrier has a rounded or tapered cross-section, with other possibilities no doubt existing.

To illustrate further, and referring now to FIG. 13, a nickel powder-filled epoxy (not shown) as is presently available can be distributed over the sensor array 200 surface. The substantially spherical shaped nickel members 1301 as comprise the nickel content within that epoxy carrier will tend to come to rest in positions other than in simultaneous physical and electrical contact with two or more pads 201 due to the action of the barriers 301 that are disposed, in this embodiment, in the gaps 202 that separate the various pads 201 from one another. This, in turn, aids in assuring that each such pad 201 will remain electrically isolated and available for its intended purpose.

Those skilled in the art may also appreciate that these barriers 301 also serve, at least in part, to aid in facilitating a more even distribution of the spherical members 1301 across the sensor array 200 itself. This occurs due to an entrapment action as the epoxy material is, for example, wiped across the sensor array 200. It may therefore also be desirable to dispose one or more such barriers other than within the gaps 202 that separate the pads 201 from one another. For example, and referring now to FIG. 14, a barrier 1401 can be located to traverse a given pad 201. This, in turn, can aid in trapping one or more spherical members 1301 on either side of this particular barrier 1401 to thereby aid in ensuring the subsequent availability of one or more viable electrical paths from such a pad 201 to a point of asperity contact.

So configured, an asperity detector sensor array can be comprised of a plurality of asperity sensor pads and a plurality of electrically conductive substantially spherical members disposed thereover, wherein barriers serve to substantially prevent the spherical members from serving as electrical pathways between adjacent ones of the sensor pads. This, in turn, aids in ensuring the initial and continued operational viability of the sensor array itself.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A sensor array apparatus comprising:
a plurality of discrete electrically conductive pads;
a plurality of electrically conductive substantially spherical members disposed over the plurality of discrete electrically conductive pads; and
raised barriers disposed between at least some of the discrete conductive pads wherein the raised barriers are comprised of insulating material.

2. The sensor array apparatus of claim 1 wherein the discrete electrically conductive pads comprise substantially square-shaped pads having lengths that do not exceed about 100 microns.

3. The sensor array apparatus of claim 2 wherein at least some of the discrete electrically conductive pads are separated from one another by gaps of no more than about 10 microns and wherein at least some of the raised barriers are at least partially disposed in the gaps.

4. The sensor array apparatus of claim 1 wherein at least one of the raised barriers has a substantially rectangular cross-section.

5. The sensor array apparatus of claim 1 wherein at least one of the raised barriers has a substantially non-rectangular cross-section.

6. The sensor array apparatus of claim 5 wherein the at least one of the raised barriers having a substantially non-rectangular cross-section has a substantially tapered cross-section.

7. The sensor array apparatus of claim 5 wherein the at least one of the raised barriers having a substantially non-rectangular cross-section has an at least partially rounded cross-section.

8. The sensor array apparatus of claim 1 wherein at least some of the discrete electrically conductive pads are separated from one another by gaps and wherein at least some of the raised barriers are at least partially disposed other than in the gaps.

9. The sensor array apparatus of claim 1 wherein at least some of the discrete electrically conductive pads are separated from one another by gaps and wherein at least some of the raised barriers are at least partially disposed in the gaps.

10. A method of facilitating provision of a sensor array comprising:
providing a plurality of discrete electrically conductive pads;
providing at least one raised barrier wherein the raised barrier is comprised of insulating material; and
disposing a plurality of electrically conductive substantially spherical members over the plurality of discrete electrically conductive pads such that the at least one raised barrier urges at least one of the electrically conductive substantially spherical members away from a position towards which the at least one of the electrically conductive substantially spherical members is otherwise inclined.

11. The method of claim 10 wherein providing a plurality of discrete electrically conductive pads further comprises providing a plurality of discrete electrically conductive pads that are separated from one another by corresponding gaps.

12. The method of claim 11 wherein providing at least one raised barrier further comprises providing the at least one raised barrier at least partially within one of the gaps.

13. The method of claim 11 wherein providing at least one raised barrier further comprises providing the at least one raised barrier other than within one of the gaps.

14. The method of claim 10 wherein providing at least one raised barrier further comprises providing at least one raised barrier having an uppermost portion that extends outwardly beyond a proximal portion of at least one of the plurality of discrete electrically conductive pads.

15. The method of claim 10 wherein providing at least one raised barrier further comprises providing at least one raised barrier having at least a portion thereof having at least one of:
a substantially rectangular-shaped cross-section;
a substantially curved cross-section;
a substantially tapered cross-section; and
a substantially stepped cross-section.

16. An asperity detector sensor array comprising:
a plurality of discrete electrically conductive pads wherein each such pad comprises an asperity sensor;
a plurality of electrically conductive substantially spherical members disposed over the plurality of discrete electrically conductive pads; and
barrier means for substantially preventing the electrically conductive substantially spherical members from serving as an electrical pathway between adjacent ones of the discrete electrically conductive pads.

17. The asperity detector sensor array of claim 16 wherein the barrier means further comprises a raised barrier having an uppermost portion that extends outwardly beyond a proximal portion of at least one of the plurality of discrete electrically conductive pads.

18. The asperity detector sensor array of claim 16 wherein at least a portion of the barrier means is positioned between adjacent ones of the discrete electrically conductive pads.

19. The asperity detector sensor array of claim 16 wherein at least a portion of the barrier means is positioned other than between adjacent ones of the discrete electrically conductive pads.
